(19) United States
(12) Patent Application Publication
(10) Pub. No.: US 2001/0030660 A1
(43) Pub. Date: Oct. 18, 2001

(54) Interactive graphical user interface and method for previewing media products

(76) Inventor: Roustem Zainoulline, Germantown, MD (US)

Correspondence Address: Roustem Zainoulline, 19911 Appledowre Circle, Germantown, MD, 20876, US

(21) Appl. No.: 09/731,814

(22) Filed: Dec. 8, 2000

Related U.S. Application Data
(60) Provisional application No. 60/169,974, filed on Dec. 10, 1999.

(51) Int. Cl. G06F 3/00

(52) U.S. Cl. 345/720; 345/856

(57) ABSTRACT

A method for enhancing the user's experience by synchronizing a multimedia feature with the movement of an indicating device. In one embodiment, a method is provided for previewing media products including the steps of providing a preview device for previewing predetermined preview clips of pre-recorded media products, interactively indicating which media product is to be previewed, and instantly playing the preview clips of an indicated pre-recorded media product in real time without noticeable delay. The plurality of pre-recorded media products may be music, video, movie, electronic game program, or a software program. An interactive graphical user interface is also provided for allowing a user to remotely preview media products through a communications link where the GUI includes a plurality of trigger fields identifying a plurality of pre-recorded media products, each of the plurality of trigger fields being associated with a preview clip. Upon moving a cursor into one of said plurality of trigger fields, a preview clip associated therewith is instantly played in real time without noticeable delay.

### BACKGROUND OF THE INVENTION

This application claims priority to U.S. Provisional Application No. 60/169,974 filed Dec. 10, 1999.

### FIELD OF THE INVENTION

The present invention is related to the field of user interfaces and methods for previewing media products. More specifically, the invention relates to interactive graphical user interfaces and methods that allow previewing of the media product prior to its purchase.

### DESCRIPTION OF RELATED ART

According to recent industry data, there are over 700 new musical compact discs (“CDs”) is released in any given week. This is largely driven by the widely different consumer musical taste which require continual expansion of musical styles and artists. At the artist level, the proliferation of new music markets, styles and tastes has caused the number of record labels to increase dramatically. The record industry has expanded from several major labels in the 1970s to more than 2,500 distributed and independent labels today. Each year more than 2,500 new artists are introduced into an already crowded market.

Despite the explosion of CD sales, most consumers are hesitant in purchasing new CD largely because of they are relatively expensive, with retail prices ranging from $14-$18. This is especially true with new artists since consumers are more reluctant to explore new and/or unproven artists for fear of wasting money. Moreover, although there are countless numbers of purchasable music, there are very few mechanisms to assist the consumer in evaluating these choices. To facilitate the musical purchase selection process, retail stores set up listening booths, kiosks, in-store juke boxes, sample computers, or other like trial stations where customers can preview some of the available products by selecting through various menus and listening to a selected song thereby allowing the customer to decide on whether he or she wants to purchase the product.

For example, a music previewing devices called PICS Previews have user interface including a television screen with a large keypad covered with miniature album covers, and these are locked into a laser disk player. A master disk which holds a fixed number of video clips is used as the source of music information. The consumer is permitted to view a video which represents a selection from the album. U.S. Pat. No. 5,237,157 to Kaplan discloses a user-interactive multi-media based point-of-preview kiosks that allow the consumer, as a subscriber, to preview music before purchasing selections at record stores. Kaplan's device incorporates a graphical user interface (GUI) and has a hi-resolution touchscreen monitor to allow the consumer to preview selected clips of a pre-recorded product by touching various items on the menu screen. Although these devices have aided in providing consumers assistance in their music purchasing decisions, these devices have failed to significantly facilitate the music preview process. The interaction and input required by the consumer in previewing numerous selections takes significant amount of time and effort as each selection is identified through a series of menus and the chosen music selection is loaded and played. Thus, the present inventor has found that this method of previewing music selections detracts from the consumer's previewing and shopping experience since much time is wasted in interacting and selecting the previews.

On a related matter, the Internet has greatly facilitated the sale and distribution of music. The Internet is a worldwide network of computers linked together by various hardware communication links all running a standard suite of protocols known as TCP/IP (transmission control protocol/Internet protocol). Software viewers known as browsers and HTTP (hypertext transfer protocol) allow a simple graphical user interface (GUI) thereby facilitating communication and data transfer over the Internet. Browsers generally reside on the computer used to access the Internet such as the consumer's computer. HTTP is a component of TCP/IP and provides users access to files of various formats using a standard page description language known as HTML (hypertext markup language). The collection of servers on the Internet using HTTP has become known as the “World Wide Web” or simply the “Web”. Through HTML, and interactive programming protocols, the author of a particular web page, or pages, is able to make information available to viewers of the web page by placing the web pages on an Internet web server in HTML format. The network path to the server is identified by a URL (Uniform Resource Locator) and, generally, any client running a web browser can access the web pages by the URL. The Web and its authoring, transmission, and display protocols, such as browsers, HTML and Java™, have become a worldwide standard for information exchange.

The Web has become very common in businesses and homes because it has proven to be convenient for various applications, such as news and data delivery, conducting banking and investment transactions, and the like. The Web has also become a major vehicle for purchasing music. For instance, numerous national retailers have created web sites for allowing consumers to preview and purchase CDs over the Web. Retailer sites such as CDNow.com, barnesandnoble.com, amazon.com and towerrecords.com all provide web sites that in one form or another, allow consumers to preview music and purchase CDs. Previews of music selections are made possible by navigating through numerous menus which identify a music category, artist and album. At the end of the navigation chain, by selecting a song title from those listed in an album, the consumer can preview the selection in the comforts of his or her home. However, like the preview kiosks discussed above, the present inventor has found that this method of previewing music selections has shortcomings in that it detracts from the consumer's previewing and shopping experience since much time is wasted in loading and/or pre-buffering and launching the previews.

As known in the art and described in U.S. Pat. No. 5,307,457 to Beitel et al., graphical user interfaces are typically provided with numerous trigger fields which can be indicated by a user moving a cursor to the field under control of a mouse or by another input device and be selected by the clicking a button on the mouse or other input device to “launch” the program, subroutine, or other processing function associated with the selected trigger field. In the above noted web sites, such trigger fields typically correspond to a specific musical genre, artist, or song. More specifically, in these prior art web sites, when a displayed song is launched by clicking a mouse button, an audio player program such as Windows Media Player™ or RealPlayer™ is launched and data which comprises a preview clip of the song is played for the consumer. In the case of the Windows Media Player™, the data constituting the preview clip of the song has to be first “downloaded” from the retailer's web site via the Internet using the compressed format called MPEG (Moving Pictures Experts Group) onto the consumer's computer and subsequently decompressed and played by the Windows Media Player™ as an audible tune. In the case of the RealPlayer™, the data constituting the preview clip of the song is continuously fed from the retailer's web site via the Internet to the consumer's computer in a “network data stream” and this data is continuously received and rendered by the RealPlayer into an audible tune. Because the music is played as the data is being received, the possibility of interruptions in music playback exists if the flow of data in the network stream is interrupted while traversing the Internet. To avoid such interruptions, a buffer of about sixteen seconds worth of playback data has to be filled with downloaded playback data prior to starting playback of the song. In addition, because of the limited bandwidth of most Internet connections as currently provided by Internet Service Providers (ISPs), the network stream method only provides “monophonic” sound rather than “stereophonic” sound which is possible using the high quality MPEG format. However, because MPEG files have to be first downloaded off the Internet, significant amount of wait time is incurred by the consumer. This further detracts from the consumer's previewing and shopping experience and is detrimental to media product vendor's selling efficiency since it takes so long to effectively preview numerous song selections.

Therefore, there exists an unfulfilled need for an improved user interface that allows consumers to preview media products in an efficient manner such that the previewing and shopping experience is enhanced for the consumer. In addition, there also exists an unfulfilled need for an improved graphical user interface that will minimize the time wasted during the previewing process. There also exists an unfulfilled need for an improved method of previewing media products which will minimize the time wasted during the previewing process such that the previewing and shopping experience is enhanced for the consumer.

### BRIEF SUMMARY OF THE INVENTION

In view of the foregoing, it is an object of the present invention to provide an improved user interface that will enhance the consumers previewing and shopping experience.

A second object of the present invention is to provide an improved user interface that allows consumers to preview media products in an efficient manner.

Yet another object of the present invention is to provide an interactive graphical user interface that will minimize the time wasted during the previewing process.

Still further, it is an object of the present invention to provide an improved method of previewing media products which will also attain the above objectives.

A fifth object of the present invention is to keep users/consumers engaged in interactive experiences by having the users/consumers interact with a media preview device in real time thereby eliminating time wasted on waiting for downloads and promoting a continuous shopping experience as well as impulse purchases.

In accordance with preferred embodiments of the present invention, these objects are obtained by an improved interactive graphical user interface for previewing media products where the preview clip of the media product is played instantly without noticeable delay upon the user/consumer indicating or activating the media product to be previewed. In this regard, the preferred embodiments provides a method for previewing media products including the steps of providing a preview device for previewing predetermined preview clips of a plurality of prerecorded media products, interactively indicating which of the plurality of prerecorded media products is to be previewed, and instantly playing the preview clips of an indicated pre-recorded media product in real time without noticeable delay. The plurality of pre-recorded media products may be at least one of music, video, movie, electronic game program, and software program. The instantaneous previewing may be attained by providing a preview device that includes an immediately accessible staging memory adapted to at least temporarily store the preview clips to allow instant playing thereof. In addition, an interactive graphical user interface is provided for allowing a user to remotely preview media products through a communications link where the GUI includes a plurality of trigger fields identifying a plurality of pre-recorded media products, each of the plurality of trigger fields being associated with a preview clip of at least one of the plurality of prerecorded media products. Upon moving a cursor into one of said plurality of trigger fields, a preview clip associated therewith is instantly played in real time without noticeable delay.

These and other objects, features and advantages of the present invention will become more apparent from the following detailed description of the preferred embodiments of the invention when viewed in conjunction with the accompanying drawings.

### BRIEF DESCRIPTION OF THE DRAWINGS

FIG. 1 is a schematic illustration of a graphical user interface for previewing a media product in accordance with one embodiment of the present invention.

FIG. 2 is a schematic illustration of a method for previewing media products in accordance with one embodiment of the present invention.

FIG. 3 is a schematic illustration of one implemented embodiment the present invention.

FIG. 4 is a schematic illustration of the method for previewing media products in accordance with another embodiment of the present invention.

FIG. 5 is a view of one embodiment of the improved graphical user interface in accordance with the present invention implemented via the Internet.

FIG. 6 is a view of a window having the improved graphical user interface of FIG. 5.

FIG. 7 is a schematic view of a trigger field which may be used in the present invention.

FIG. 8 is a view of a window having the improved graphical user interface in accordance with another embodiment.

### DETAILED DESCRIPTION OF THE INVENTION

Generally stated, the present invention is directed to a graphical user interface where the user's experience with a multimedia feature such as audio or visual playback can be changed in real-time in accordance with the position of an indicating device. The indicating device can be any commonly used device such as a pointer, tracking instrument such as a cursor, a mouse, a joystick, a touch screen, etc. Thus, the user's experience with the multimedia feature is synched or synchronized to the movement of the indicating device.

In the embodiments described herein below, an improved interactive graphical user interface and method is provided for previewing media products such as music, videos, movies, electronic game programs and even software programs, etc. where a preview clip of the media product is played instantly without noticeable delay upon the user/consumer indicating or activating the media product to be previewed. Thus, the user's experience with the multimedia feature, i.e. previewing of the media product, is synchronized to the movement of the indicating device. FIG. 1 schematically illustrates a graphical user interface 1 (hereinafter “GUI”) for previewing media products in accordance with one embodiment of the present invention. As can be seen, the GUI 1 displays an array of trigger fields 3 on a display device 10 of the preview device 2, each of the trigger fields 3 corresponding to a pre-selected preview clip 5 of a media product. In accordance with the present embodiment, the preview clips 5 are instantly played by the preview device 2 when the user/consumer (not shown) interactively indicates via the GUI 1 which media product he or she desires to preview, the playback being in real time without noticeable delay. In this manner, the present invention allows the user to preview media products in an efficient manner with minimal waste of time such that the previewing and shopping experience is enhanced thereby encouraging consumer's extended interaction with, and exploring of, the selection of media products offered, and thereby enhancing prospects of purchasing of one of the previewed media products offered.

FIG. 2 schematically illustrates the general method in accordance with the present invention. As can be seen, the present interactive GUI method includes the steps of:

6—providing a previewing device with a graphical user interface that allows a consumer to preview pre-selected preview clips of various pre-recorded media products;

7—interactively indicating which of the various pre-recorded media product is to be previewed; and

8—instantly playing the preview clip of the indicated pre-recorded media product in real time without noticeable delay.

FIG. 3 schematically illustrates one possible embodiment of the hardware for implementation of the present invention. As can be seen, a preview device 2 having a CPU 4, RAM memory 6, staging memory 8, a display device 10, a sound device 11 and an input device 12, which in the present embodiment, are all connected to a bus 14 that allows electrical communication between these components and control of the preview device 2. Other hardware and/or software components may include an operating system 18, GUI program 20, device programs 22, a player program 24 for playing the indicated preview clip and an optional secondary storage 25. The bus 14 is also connected to a media product storage device 16 which stores the various pre-recorded media products and the pre-selected preview clips of these various pre-recorded media products. The preview device 2 is adapted to load the player program 24 into the RAM memory 6. The preview device 2 is also adapted to retrieve and pre-loaded preview clips of various pre-recorded media products stored in the media product storage device 16 into the immediately accessible staging memory 8 of the preview device 2 such as in the secondary storage 25. Selection of the pre-recorded media products of which are representative preview clips have been pre-loaded into the staging memory 8 are displayed on the display device 10 via the GUI program 20. As shown, the user/consumer 26 (hereinafter “user”) interacts with the preview device 2 via the display device 10 and the input device 12 to indicate which of the pre-recorded media products is to be previewed.

Upon receiving interactive indication from the user 26 via the input device 12 as to which of the pre-recorded media products is to be previewed, the preview device 2 launches playback of the preview clip of the indicated pre-recorded media product from the staging memory 8 via the player program 24 (which may be executed using the CPU 4 and the RAM memory 6) such that the preview is played instantly in real time. The user may also quickly evaluate the media product selections by interactively activating trigger fields among the various media products displayed on the display device 10. In accordance with this embodiment, as another media product is indicated by the user, the playback of the preview clip of the previously indicated media product is terminated upon crossing out of (i.e. leaving) the corresponding trigger field and the playback of the preview clip of the newly indicated media product is instantly started upon crossing into (i.e. entering) a corresponding trigger field. The preview clips pre-loaded in the staging memory 8 may be over-written by other preview clips when the user 26 indicates that he or she has completed interacting with the selection of the media products displayed on the display device 10 via the GUI program 20 by taking action or command such as “Scroll to the Next Selection Page” or “Close the Window”.

The preview clip of the selected music, video, movie, etc. is played through the sound device 11 and/or display device 10 depending on the media product. Thus, songs/music/sound is instantly played through the sound device 11 while video clips of the video, movie, etc. are played through the video display device 10 as well. This instant, real time playing of the preview clip is made possible because the preview clips have been pre-loaded into the staging memory 8 of the preview device 2 thereby eliminating the wait time associated with “downloading” or establishing and pre-buffering a “network data stream” as required in prior art devices and methods when a preview of the media product is desired or indicated. In this manner, the user's experience with the multimedia feature is synched or synchronized to the movement of the indicating device. In this regard, the present embodiment provides an improved interactive graphical user interface and method for previewing media products where the preview clip of the media product is played instantly on demand without noticeable delay upon the user/consumer indicating (or activating) the media product to be previewed. This allows the user to preview media products in an efficient manner with minimal waste of time such that the previewing and shopping experience is enhanced thereby encouraging consumer's extended interaction with, and exploration of, the selection of media products offered and, thereby enhancing prospects of purchasing of one of the previewed media products offered. In this regard, the preview clips may be carefully selected to entice the user/consumer to purchase the product. For instance, the preview clips of a song may be the catchy chorus part of the song. For movies, it may be a trailer scene which is easily recognizable as the scene from the movie, etc.

As previously noted, the media products to which the present invention applies includes music, videos, movies, etc. The present invention may also be applied to electronic game programs and even software programs etc. where previews of the products or information about the products will facilitate the user/consumer in making the decision to purchase the media product. Thus, whereas in the case of music, the indicated song is previewed via the sound device 11, in case of other media products, a video clip is also displayed together with music/sound via the display device 10 so that videos, movies, electronic game programs and even software programs, etc. may be previewed visually. In addition, because the present invention is an interactive GUI and method for previewing media products, the present invention may be applied across numerous different hardware implementations of preview devices and methods. For example, the present invention may be readily applied to web sites on the World Wide Web that preview, sell and/or distribute the above noted media products. Furthermore, the present invention may also be implemented in listening booths, kiosks, in-store juke boxes, sample computers, or other preview stations such as set top boxes like Web TV™, Internet appliances and the like to allow customers to preview available media products.

To clearly illustrate the preferred embodiments of the present invention and how the present invention may be applied and implemented to provide the user with experience with the multimedia feature which is synchronized to the movement of the indicating device, several embodiments of an improved interactive graphical user interface in accordance with the present invention are discussed herein below. However, it should be noted that the present invention is not limited thereto and the present invention may be practiced in other alternative embodiments and applied in other implementations not specifically disclosed or discussed below.

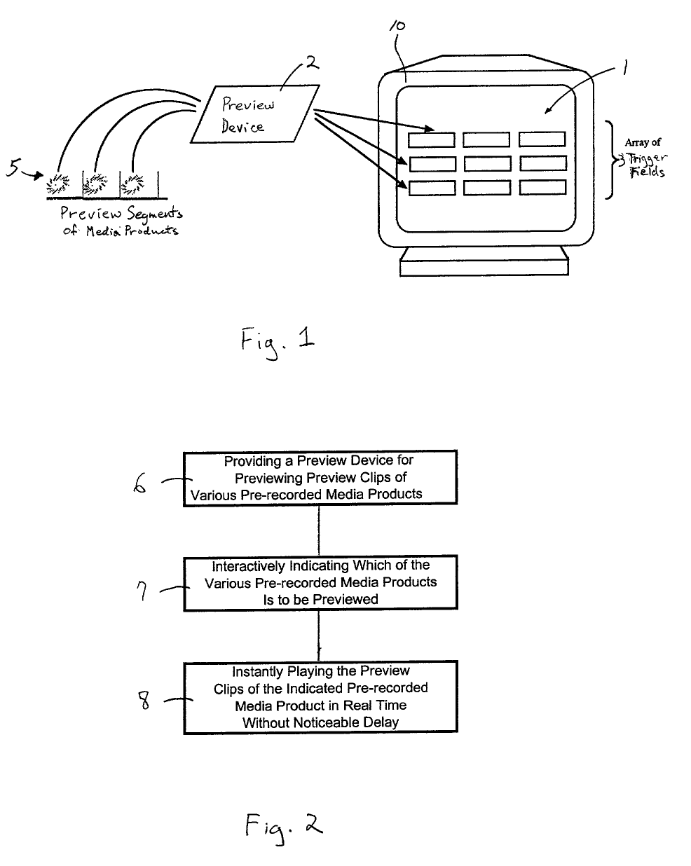

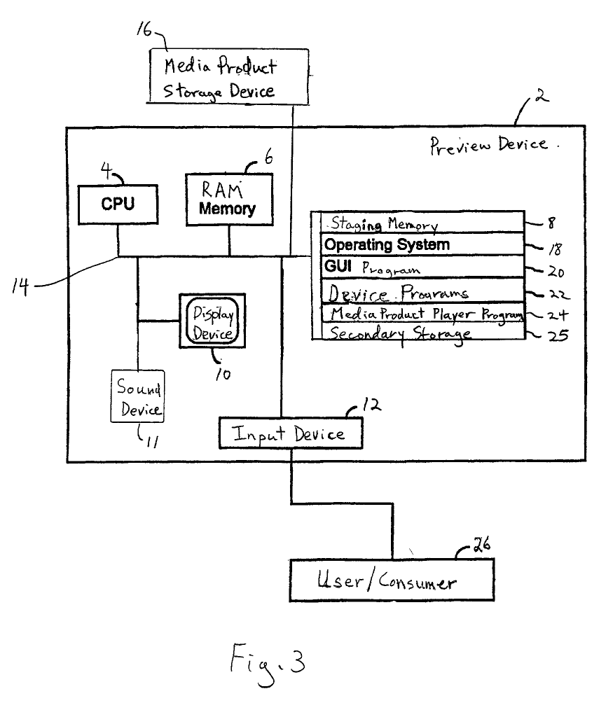

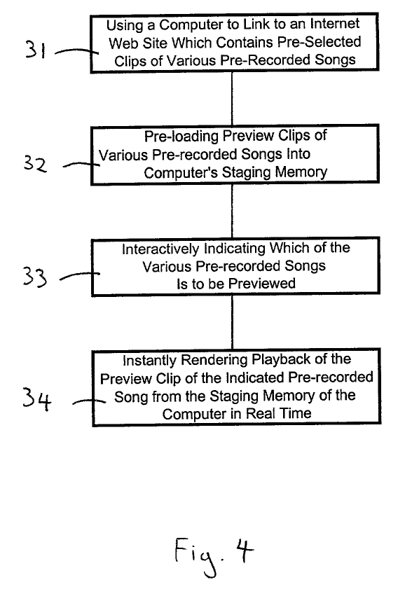

As noted above, the present invention provides an effective method for enabling a user to preview a clip of media products such as pre-recorded music and songs from an Internet web site which contains pre-selected clips of the pre-recorded music and songs by using a computer which serves as the preview device. As can be seen in FIG. 4, the method used in such an implementation includes the steps of:

31—using a computer to establish a telecommunications link to an Internet web site which contains pre-selected preview clips of various pre-recorded songs;

32—pre-loading the preview clips of the various pre-recorded songs into the user's computer's staging memory;

33—interactively indicating which of the various pre-recorded songs is to be previewed; and

34—instantly rendering playback of the preview clip of the indicated prerecorded song from the user's computer's staging memory in real time.

As can be appreciated, the illustration of FIG. 3 is equally applicable to the above described computer/Internet implementation of the present invention. In this implementation, the preview device 2 would be the user's computer with its associated components. Of course, components such as the CPU 4, RAM memory 6 and bus 14 are known to be present in a conventional computer. In addition, the staging memory 8 would be equivalent to a portion of the hard drive and the various other components stored in the hard drive including an operating system, device drivers, software programs, etc. The input device 12 may be a mouse, a track ball, a touch pad or other devices. The display device would be the monitor and the sound device 11 comprised of the sound card and speakers. The media product storage device 16 would be the web site server which contains the pre-recorded songs and the pre-selected preview clips of these songs. In this implementation, a communication link with the web site server (i.e. media product storage device) is established over the Internet by means of a communication device such as a modem over a communications medium such as telephone line, ISDN, DSL, fiber-optic, cable, satellite dish and PCS system (not shown).

As noted previously, in the above described embodiments, the pre-loaded preview clips of the song or the media product may be stored in the staging memory 8 which may happen to be a cache memory area, in effect, a designated part of the hard drive of the computer used by a standard Web browser software. This embodiment provides flexibility and ease of use in the Internet implementation discussed above since commonly used browsers such as the Microsoft's Internet Explorer™ and the Netscape's Navigator™ already utilize such hard drive caching memory management schemes for temporarily storing data from the web sites being visited. Because the hard drives have fast data access times and transfer rates, the preview clips stored in the hard drive cache of the computer can be accessed and played in an instant without noticeable delays. Another advantage in utilizing an Internet browser is attained in the fact that these commonly used browsers typically also include a embedded sound program within the browser itself so that such program is readily available in RAM memory of the computer to play the preview clips of the pre-recorded music and songs. In alternative embodiments however, the pre-loaded preview clips may alternatively be stored in the RAM memory itself.

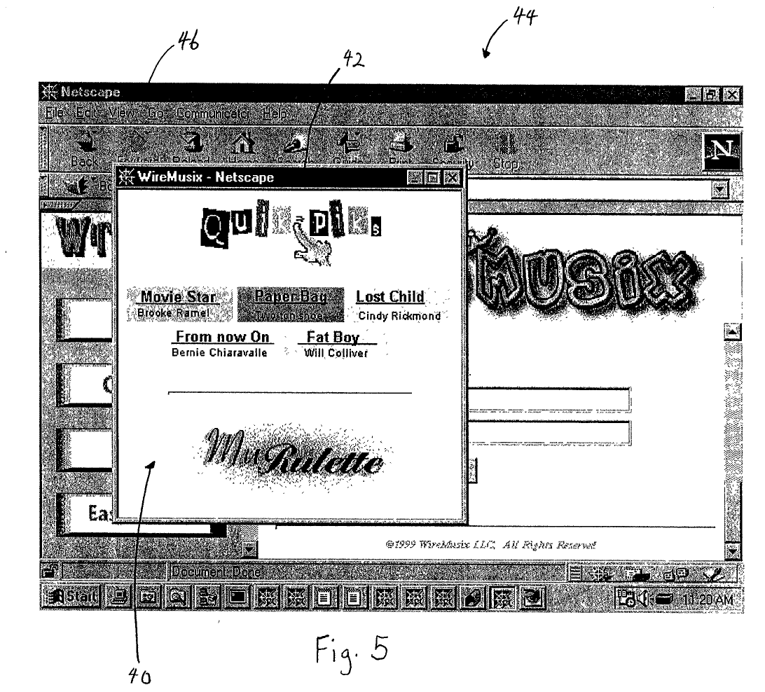

For further elaboration on the implementation described above, FIG. 5 illustrates an improved interactive graphical user interface 40 (hereinafter “GUI”) in accordance with one embodiment of the present invention as implemented in a preview window screen 42 of an Internet web site 44. The web site 44 was accessed using the browser Netscape Navigator™ 46 and the web site 44 is of the type that allows the user to preview pre-recorded songs and purchase and/or download these songs via the Internet. In this particular illustrated example, the web site 44 shown is www.wiremusix.com but other web sites may practice the present invention in the manner disclosed.

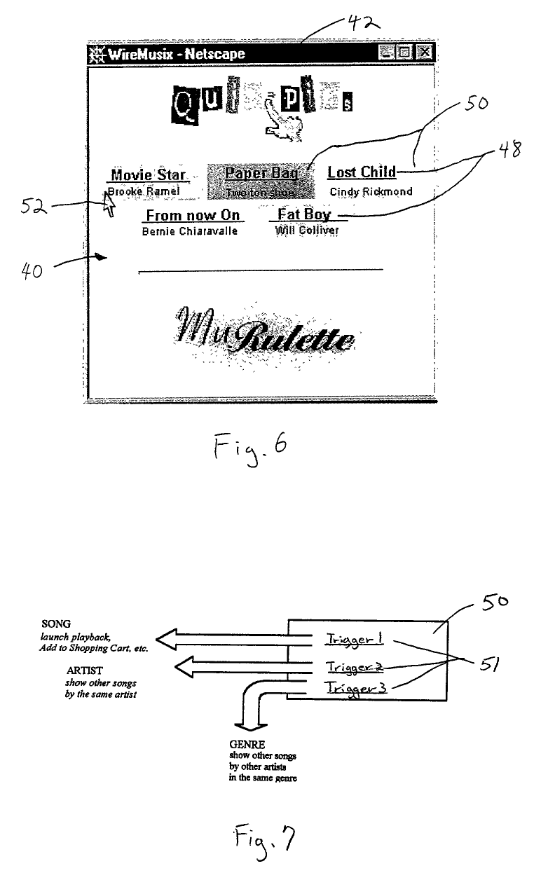

For discussion purposes, a separate view of the preview window screen 42 is more clearly shown in FIG. 6. As can be seen, the interactive GUI 40 contains a page featuring a plurality of song selections 48 which are provided within corresponding trigger fields 50. When the preview window screen 42 is launched by the user visiting the previous screen (not shown) of the web site 44, the preview clips corresponding to the plurality of song selections 48 are pre-loaded into the cache memory in the hard drive by the browser Netscape Navigator™ 46. Once the GUI 40 in the preview window screen 42 is displayed, the consumer indicates one of the plurality of song selections 48 which he or she would like to preview by moving the cursor 52 into one of the trigger fields 50 by means of a mouse or other input device such as a track ball, touch pad or infrared remote control (not shown). When this indication by the consumer occurs, playback of the preview clip of the song indicated is instantly launched from the cache memory of the hard drive in real time as the user/consumer manipulates the cursor. Thus, in the illustration of FIG. 5, the song “Movie Star” is played instantly for the consumer in real-time by mere indication of which song to preview via moving the cursor 52 over the trigger field without the consumer having to perform an added step of clicking on the song, waiting for a “download” of the preview clip or waiting to establish and pre-buffer a “network data stream” as required in the prior art preview graphical user interfaces. As another song is indicated by the user via moving the cursor 52, the playback of the preview clip of the previously indicated song “Movie Star” is terminated and the preview clip of the newly indicated media product is instantly played. Again, this immediate playing of the newly selected preview clip is attained by the fact that the preview clip is pre-loaded in the cache memory on the hard drive.

In the present illustrated embodiment, the preview is actually started when the cursor 52 is merely moved into a trigger field 50 and stopped when the cursor 52 is moved out of the trigger field 50. Thus, in this example, the instructions and subroutines associated with each of the trigger fields 50 are executed upon mere movement of the cursor 52 into the trigger field 50. The additional action of clicking on the mouse button in the trigger field 50 is not required for previewing in this embodiment. A clip of a computer code that may be used to implement the embodiment of the present invention as illustrated in FIG. 6 of the application is reproduced in APPENDIX A reproduced below. This allows the additional action of clicking on the mouse button to be reserved for another functionality. For instance, in the illustrated GUI 40 of FIG. 6, the song titles 48 within the trigger fields 50 are themselves, triggers having associated instructions and subroutines for additional features and/or functions. For instance, during or after the preview of a particular indicated song, the user may clicking on the song title itself to:

a) launch a streaming playback of the complete song from a server computer;

b) launch download of the complete song;

c) launch playback from a local media product storage device;

d) mark the song and/or media product with the song for placement in a “shopping cart” for a subsequent purchase during checkout; or

e) retrieve a list other songs by the same artist or in the same genre.

In this regard, the trigger field 50 may be provided with more than one textual tags, each of the textual tags being associated with a different function or feature. Such a trigger field 50 is schematically illustrated in FIG. 7. As can be seen, here the trigger field 50 is provided with three textual tags 51, each of which fires execution of one or more of the functions shown (at the end of the corresponding arrows). Thus, Trigger 1 may function to launch a playback of the complete song, Trigger 2 may function to display a list of other songs by the same artist while Trigger 3 may function to display other songs in the same genre.

Of course, it should be noted that in an alternative embodiment, the GUI 40 may be such that the user must move the cursor 52 into one of the trigger fields 50 and click on the trigger field 50 in order to start the previewing of the selected preview clip. Even in this embodiment, because the preview clips are pre-loaded, the selected preview clip is played much more quickly than the prior art GUIs which require launching of the selected song as well as waiting for a “download” of the preview clip or waiting to establish a “network stream”. However, the previously described embodiment where the preview clips are played when the cursor 52 is moved into the trigger field 50 is preferred because this facilitates and enhances the previewing experience of the user/consumer and further allows an additional different function to be assigned to the action of clicking on the trigger field 50.

It should also be noted that the text of song selections 18 need not be enclosed in the visually distinct trigger fields 50 as shown in FIG. 6 but instead, the trigger fields may also be made transparent such that only the textual info, i.e. title and/or artist name, label etc. of the song selections 18 are visible. Moreover, the web site 44 may be provided with additional features that allow the user/consumer 26 to purchase the music/song previewed, download complete songs, etc. for later playing on the computer or other devices such as Diamond's Rio™ MP3 players. Of course, as previously noted, the media products previewed and sold may include videos, movies, electronic game programs and even software programs, etc. In this regard, the user/consumer may be provided with an electronic “shopping cart” and be provided with features such that the customer can “check out” of the web site by paying for the desired media products. However, these features are known in the art and need not be discussed in further detail here.

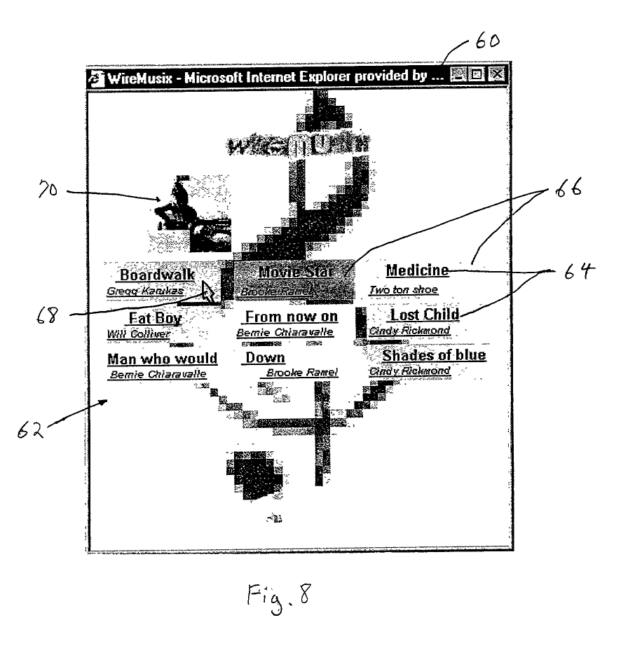

In yet another alternative Internet implemented embodiment, the present invention may also be used to preview video clips as well. FIG. 8 illustrates such an embodiment where a preview window screen 60 from the Internet web site is shown. As can be recognized, the web site and the preview window screen was accessed using the Microsoft's Internet Explorer™ browser. Like the prior embodiment, the interactive GUI 62 includes a plurality of song selections 64 which are accessible via corresponding trigger fields 66. When the preview window screen 60 is launched by the user from the previous screen (not shown) of the web site, the preview clips which include an audio clip or signal and a video clip or signal corresponding to the plurality of song selections 64 are pre-loaded into the cache memory on the hard drive via the browser Internet Explorer™. Once the GUI 62 in the preview window screen 60 is displayed, the consumer activates or indicates one of the plurality of song selections 64 which he or she would like to preview by moving the cursor 68 into one of the trigger fields 66 via a mouse or other input device such as a track ball or touch pad (not shown). When this indication or activation by the consumer occurs, the preview clip including the audio clip and a video clip of the song indicated is played instantly in real time from the cache memory on the hard drive for the consumer without noticeable delay. Thus, in the illustration of FIG. 8, the audio clip as well as the video clip of the indicated or activated song “Boardwalk” is played instantly for the consumer in real-time by mere indication of which song to preview via the cursor move 52 without the consumer having to perform an added step of clicking to launch download to preview the song, waiting for a download of the preview clip to complete or waiting to establish and pre-buffer a network stream. A segment of a computer code that may be used to implement the embodiment of the present invention as illustrated in FIG. 8 of the application is reproduced in APPENDIX B reproduced below.

As can be clearly seen, in the present embodiment, the video clip 70 is displayed in the GUI 62 in the preview window screen 60. The video clip 70 can also be rendered by the browser in use, which in this case, is the Internet Explorer™. And as described relative to FIG. 7, the trigger fields 66 in this embodiment are provided with more than one textual tags, each of the textual tags being associated with a different function or feature. In this manner, the user/consumer is allowed to preview both the audio clip and a video clip of the selected song instantly without noticeable delay so that the previewing experience is enhanced thereby encouraging consumer's extended interaction with, and exploring of, the selection of media products offered and, therefore enhancing prospects of purchasing of one of the previewed media products offered.

In addition, other media products including videos, movies, electronic game programs and even software programs, etc. may be previewed in the manner described above by providing a video clip as well as an audio clip to the preview clip. In particular, video and movie preview clips may be provided with a sound clip having the dialog and/or music and a video clip having the corresponding scene or clip. Electronic game programs may be previewed in a similar manner by providing a clip of a game scene together with the corresponding sound effects. Software programs may also be previewed by either displaying key features or functions of the program or by providing a summary of such features or functions.

As can be seen from the examples discussed above, the present invention provides an improved interactive graphical user interface and method for previewing media products. The present invention allows the consumer to preview clip of the media product instantly without noticeable delay when the user/consumer indicates the media product to be previewed. By minimizing the time wasted in waiting to complete a download or establishing and pre-buffering a network stream, the present invention allows the user to preview media products in an efficient manner. This enhances the previewing and shopping experience as well as encouraging consumer's extended interaction with, and exploring of, the selection of media products offered thereby enhancing prospects of purchasing of one of the previewed media products offered.

As previously noted, the present invention may also be implemented in listening booths, kiosks, in-store juke boxes, sample computers, or other preview stations such as set top boxes like Web TV™ to allow customers to preview some of the available media products. For example, in such alternative implementations, the input device 12 and the display device 10 of FIG. 2 may be combined into a touch sensitive screen. In accordance with one embodiment of the present invention, the preview clip of the pre-recorded media product is instantly played for the consumer when the user touches the screen to select the media product to be previewed. Of course, listening booths, kiosks, in-store juke boxes, sample computers, or other preview stations may instead, be provided with a mouse, joystick, track ball or other indicating device instead of a touch screen to allow indication of the desired selection by merely moving the cursor into a trigger field as discussed in the previous embodiments.

In addition, in such implementations which are commonly stand alone units, the media product storage device 16 may be one or more of numerous data storage devices such as a mini-disc, CD, DVD, Laser Disc, etc. It is important to note however, that in accordance with one embodiment of the present invention, the staging memory 8 is used which provides for a faster access time than these storage media are typically capable of.

The present invention may also be used in still other implementations as well. For instance, a preview CD may be issued by a record label such as Sony™ or RCA™ which is readable via a CD-ROM player of a consumer appliance that allows previewing of the selections encapsulated on the CD in the manner described above. Moreover, the CD may be provided with code for accessing an Internet web site for a down loading or establishing network stream to receive the complete media product when the media product indicated is launched. Alternatively, both preview clips of a media products as well as the complete media products may be distributed on a high capacity storage such as DVD and the present invention may be used with a DVD player to provide an improved interactive GUI and method for previewing and navigating around and playback of the contents of the DVD using the controls on a control panel of such an appliance and/or infrared remote control. Thus, in this embodiment, the GUI and method in accordance with the present invention provides a navigational tool to aid the user in identifying what the user desires to play on the DVD.

It is important to note that whereas most of the specific implementations of the present invention discussed above, the present invention is not limited thereto. It is reiterated that the present invention is directed to a method for enhancing the user's experience by synchronizing a multimedia feature with the movement of an indicating device. In one embodiment of the present invention, an improved interactive graphical user interface and method for previewing media products is provided where the preview clip of the media product is played instantly without noticeable delay when the user/consumer indicates the media product to be previewed. Preferably, this is attained by providing a GUI with a plurality of trigger fields where the preview clips are instantly played when a cursor is moved into the trigger field. And while the implementations thus far discussed require the preloading of the preview clips into the staging memory or the RAM memory of the preview device, this need not be required in order to practice this preferred embodiment of the present invention. As an example of this alternative embodiment, a preview device which stores the preview clips in a solid state, or flash- memory such as Sony Corp.'s Memory Stick™ products may be provided in which such pre-loading step is eliminated since the Memory Stick™ is a solid state device and data stored thereon can be instantly accessed. Thus, in this implementation, the preview clips stored on the Memory Stick™ may be played instantly when the user indicates the media product to be previewed by moving the cursor into the trigger field. Therefore, as the data storage technology continues to improve to attain faster access times and transfer rates, such pre-loading of the preview clips as required in CD-based, DVD-based and current Internet implementations would cease to be necessary and the GUI and method of present invention may be practiced in hardware implementations based on direct communication with media storage devices.

From the foregoing, it should now be apparent how the present invention improves the user's experience by synchronizing the multimedia feature with the movement of the indicating device. This is attained in one embodiment by providing an improved interactive graphical user interface and method for previewing media products. In addition, it can be seen how the present invention allows a user/consumer to instantly preview clip of the media product in real time with minimal delay. Furthermore, it can also be seen how the present invention minimizes the time wasted due to downloading or establishing and pre-buffering a network stream thereby allowing the user to preview media products in an efficient manner to enhance the previewing and shopping experience of the user/consumer. Moreover, such enhanced previewing and shopping experience will encourage consumer's extended interaction with, and exploring of, the selection of media products offered and, thereby enhancing prospects of purchasing of one of the previewed media products offered.

While various embodiments in accordance with the present invention have been shown and described, it is understood that the invention is not limited thereto. These embodiments may be changed, modified and further applied by those skilled in the art. Therefore, this invention is not limited to the details shown and described previously but also includes all such changes and modifications.

I claim:

1. A method for previewing media products comprising the steps of:
providing a preview device for previewing predetermined preview clips of a plurality of pre-recorded media products;
interactively indicating which of said plurality of pre-recorded media products is to be previewed; and
instantly playing said preview clips of an indicated pre-recorded media product in real time.

2. The method of claim 1, wherein said plurality of pre-recorded media products is at least one of music, video, movie, electronic game program, and software program.

3. The method of claim 2, wherein said preview device includes an immediately accessible staging memory adapted to at least temporarily store said preview clips to allow instant playing thereof.

4. The method of claim 3, wherein said preview clips of said plurality of prerecorded media products are stored in a media product storage device.

5. The method of claim 4, further including the steps of retrieving and preloading said preview clips into said staging memory of said previewing device from said media product storage device.

6. The method of claim 5, wherein said previewing device is at least one of a computer, a set top box, an Internet appliance connected to a communications link, a listening booth, a kiosk, an in-store juke box, and a previewing computer.

7. The method of claim 5, wherein said media product storage device is at least one of a hard drive, a server, a mini-disc, a CD, a DVD, a Laser Disc, and a solid state memory device.

8. The method of claim 5, wherein said previewing device is a computer and said staging memory is at least one of RAM, cache memory of a hard drive, and a portion of a hard drive.

9. The method of claim 5, wherein said previewing device includes a display device having a graphical user interface (GUI) and objects representing said preview clips pre-loaded into said staging memory are displayed on said display device via said GUI.

10. The method of claim 9, wherein the step of interactively indicating which of said plurality of pre-recorded media products the user wants to preview includes the step of moving a graphically embodied cursor of said GUI over a trigger field displayed on said GUI.

11. The method of claim 10, wherein the step of instantly playing said preview clip of an indicated pre-recorded media product occurs upon said cursor entering said trigger field.

12. The method of claim 11, further including the step of instantly terminating playing of said preview clip of an indicated pre-recorded media product when said cursor leaves said trigger field.

13. The method of claim 10, wherein said cursor is moved by an input device operated by the user, said input device being at least one of a mouse, a track ball, a touch pad and a touch screen.

14. The method of claim 1, wherein each of said predetermined preview clips are segments representative of contents of one of said plurality of pre-recorded media products.

15. An interactive graphical user interface for allowing a user to preview media products comprising:
a plurality of trigger fields identifying a plurality of pre-recorded media products, each of said plurality of trigger fields being associated with a preview clip of at least one of said plurality of pre-recorded media products;
wherein upon moving a cursor into one of said plurality of trigger fields, a preview clip associated therewith is instantly played in real time.

16. The interactive graphical user interface of claim 15, wherein said GUI is further adapted to instantly terminate playing of said preview clip associated with said one of said plurality of trigger fields when said cursor leaves said trigger field.

17. The interactive graphical user interface of claim 15, wherein said cursor is moved by an input device operated by the user, said input device being at least one of a mouse, a track ball, a touch pad and a touch screen.

18. The interactive graphical user interface of claim 15, wherein said plurality of trigger fields further include at least one textual tag adapted to be launched by a user clicking on said trigger, said at least one textual tag including associated instruction embedded therein for executing a subroutine program.

19. The interactive graphical user interface of claim 18, wherein said subroutine program launches a streaming playback of a complete media product from a remote server.

20. The interactive graphical user interface of claim 18, wherein said GUI is provided for access to a remotely located website, and said subroutine program launches download of said pre-recorded media product being previewed into a remotely located computer.

21. The interactive graphical user interface of claim 20, wherein said download of said pre-recorded media product being previewed constitutes purchasing of said pre-recorded media product.

22. The interactive graphical user interface of claim 18, wherein said GUI is provided for access to a remotely located website, and said subroutine program flags said pre-recorded media product being previewed for purchase, said website further comprising a “shopping cart” which is at least temporarily assigned to a visitor of said website, said “shopping cart” being adapted to keep track of media products flagged for purchase.

23. The interactive graphical user interface of claim 22, wherein upon purchasing of said pre-recorded media product, said purchased pre-recorded media product is downloaded into a remote computer through said communications link.

24. The interactive graphical user interface of claim 15, wherein said plurality of pre-recorded media products is at least one of music, video, movie, electronic game program, and software program.

25. The interactive graphical user interface of claim 15, wherein said preview clip is a segment representative of contents of one of said plurality of pre-recorded media products.
